(19) United States
(12) Patent Application Publication
(10) Pub. No.: US 2011/0076431 A1
(43) Pub. Date: Mar. 31, 2011

(54) PREFORM INTENDED TO FORM A HOLLOW STRUCTURAL MECHANICAL PART, RESULTING PART AND METHOD FOR PRODUCING SAID PREFORM

(75) Inventor: Bertrand Desjoyeaux, Sainte Adresse (FR)

(73) Assignee: AIRCELLE, Gonfreville L'Orcher (FR)

(21) Appl. No.: 12/995,306

(22) PCT Filed: Jun. 2, 2009
(86) PCT No.: PCT/FR2009/051033

§ 371 Date: Nov. 30, 2010

(30) Foreign Application Priority Data
Jun. 11, 2008 (FR) 0803241

(51) Int. Cl. B29B 11/16; D03D 25/00; D03D 41/00; B29C 70/34

(52) U.S. Cl. 428/36.1; 139/384 R; 139/11

(57) ABSTRACT

The invention relates to a preform (300) intended to form a hollow structural mechanical part, said preform (300) comprising: a central body (301) forming a median plane (307) and extending substantially along a main axis (309) contained in the median plane (307); and two side parts (303, 305) extending substantially along the median plane (307) along a secondary axis (311) substantially perpendicular to the main axis (309), the central body (301) and each side part (303, 305) including weft fibres interconnected by binder fibres. The weft fibres extend along substantially parallel planar weft layers, and the thickness (E) of each side part (303, 305) decreases along the secondary axis (311) moving away from the central body (301). The invention also relates to a method for producing one such preform, as well as to a hollow structural mechanical part.

### TECHNICAL FIELD

The present invention relates to a preform intended to form a hollow structural mechanical part.

The present invention also concerns a method for producing such a preform as well as a hollow structuring part.

### BACKGROUND

In the context of the present invention, a hollow structuring mechanical part is a part participating in the structure of an aircraft and including a hollow central area or a recess. Examples include a rod with a hollow central body or a boxed part.

It is known to produce such parts from a preform with a base of woven fibers, called dry, and made integral with each other by injecting a resin.

The dry fibers are divided into weft fibers and binder fibers (also called chain fibers). The weft fibers are generally oriented in a defined direction. These weft fibers are also superimposed in several substantially parallel layers, called “plies” or “weft layers.”

The binder fibers are arranged in a direction substantially perpendicular and coplanar to the direction of the weft fibers.

The so-called “2D” traditional weaving, shown in FIG. 1, corresponds to a weave in which each binder fiber 121 alternatingly passes above and below weft fibers 123 of a same weft layer 125. The weave pattern corresponding to the frequency of the interlacing of the binder fibers 121 around the weft fibers 123 can be of any known type, for example of the taffeta, satin or twill type.

The “2.5D” weave, shown in FIG. 2, corresponds to a weave in which each binder fiber 221 connects weft fibers 223 of at least two different weft layers 225, in particular adjacent weft layers 225a, 225b and 225c.

In patent application WO 2007/060306, a preform intended to form a hollow mechanical part is proposed. The preform includes a body with a base of dry woven fibers following the 2.5D weave. The body of the preform has a constant thickness along the transverse section. Because of this, during winding of the preform on itself to form the hollow mechanical part, the weft layers of the body slide in relation to each other such that the function of the body is formed by two beveled ends overlapping each other.

“Beveled” means here that after winding, each side part has an oblique edge.

However, although the weave of this type of preform is wide-meshed enough to allow the weft fibers to slide in relation to each other, the weft and binder fibers have a tendency to come undone. The preform then has weak cohesion.

If the weave is tight enough to avoid such a drawback, then the binder fibers tend to retain the weft fibers. The weft fibers have trouble sliding in relation to each other. Because of this, there may be alignment and/or buckling problems of the weft fibers upon shaping and at the junction area, which decreases the quality thereof.

Furthermore, the length of the beveled surface of such a preform is limited and has shown itself to be insufficient to ensure optimal transmission of mechanical stresses from one end of the preform to the other. The mechanical strength during certain uses of the hollow mechanical part is not completely satisfactory.

### BRIEF SUMMARY

One aim of the present invention is therefore to provide a preform including dry fibers that has better mechanical resistance.

One aim of the present invention is also to provide a preform that is easy to implement.

To that end, according to a first aspect, the invention concerns a preform intended to form a hollow structural mechanical part, said preform comprising:
a central body forming a median plane and extending substantially along a main axis contained in the median plane, and
two side parts extending substantially along the median plane along a secondary axis substantially perpendicular to the main axis,

the central body and each side part including weft fibers bound to each other by binder fibers, said weft fibers extending along substantially parallel planar weft layers,

wherein the thickness of each side part decreases along the secondary axis moving away from the central body.

The preform of the present invention has the advantage of including side parts that, perpendicular to the median plane, have a substantially trapezoidal cross-section, or substantially triangular cross-section, whereof the number of plies and the thickness of the side parts can vary as a function of the use of the preform according to the invention.

“Median plane” refers to a plane passing through the median section of the central body.

The side parts are therefore “beveled” flat before any process for producing the hollow structural mechanical part, in particular any process of winding one or several preforms according to the invention. Each side part has a surface able to be situated opposite another surface of a side part so as to cover the latter while defining a broader and more mechanically resistant junction than in the prior art. In particular, due to the shape of the side parts, the mechanical stresses on either side of the junction are better transmitted from one side part to the other, which improves the mechanical resistance of the structural mechanical piece. Thus, the latter has better mechanical resistance for a less significant mass than that of the mechanical parts of the prior art.

Moreover, the preform of the present invention has the advantage of being easy to implement.

According to other features of the invention, the preform according to the invention includes one or several of the following optional features, considered alone or according to all possible combinations:
at least part of the binder fibers binds weft fibers of the central body and each side part belonging to different weft layers, which improves the mechanical resistance between the layers and that of the preform according to the invention and makes it possible to obtain a handleable preform that does not come undone,
the binder fibers bind weft fibers of a same weft layer in each side part and said binder fibers bind the weft fibers belonging to different weft layers in the central body, which makes it possible to improve the sliding of the relative weft layers, during winding, and thereby to keep correctly aligned circumferential fibers improving the junction between the two side parts while avoiding any buckling of the weft fibers,
substantially all of the binder fibers bind weft fibers of a same weft layer, said weft fibers belonging to the central body and each side part, which makes it possible to decrease the drop of the fibers and to select the weave and fibers that are most adapted to improving the mechanical property of the preform, in particular in compression in the central area of the structural mechanical part by reducing shrinkage of the fibers,
the weft fibers of the central body and/or of the side parts are bound by a plurality of additional fibers substantially perpendicular to the median plane, which makes it possible to bind the different weft layers flat, thereby making it possible to improve the alignment of the weft fibers and improve the handling of the preform according to the invention,
at least one additional fiber forms a non-zero implantation angle with the normal of the median plane, which makes it possible to improve the sliding of the weft layers and thus obtain the necessary winding for the geometry of the structural mechanical part,
the diameters of the binder fibers of at least one side part have different values, which makes it possible to obtain more fine layers and optimize the slope of the side parts,
the minimum thickness of each side part corresponds to the diameter of a weft fiber or of two weft fibers,
the diameter of a binder fiber is between one fifth and five times the diameter of a weft fiber,
the value of the slope of each side part is between 3 mm long for 1 mm thick and 15 mm long for 1 mm thick, which makes it possible to obtain excellent mechanical continuity and therefore an optimal junction area,
the diameter of the weft fibers of the last layer or of the last two layers of the side parts have values lower than the diameter of the weft fibers of the other weft layers, which makes it possible to obtain a surface layer able to be situated opposite another surface layer in the finest junction area and thereby optimize the mechanical resistance of the junction area,
the end weft fibers belonging to the end weft layers substantially bind all of the binder fibers belonging to the end of a side part.

According to a second aspect, the invention concerns a method for producing a preform according to the invention, wherein it includes a step (A) for forming a central body comprising along a median plane then a step (B) for forming two side parts along a thickness that decreases along the secondary axis moving away from the central body, each side part being substantially contained in the median plane, the central body and each side part comprising weft fibers bound to each other by binder fibers, said weft fibers extending along parallel planar weft layers.

The method according to the invention has the advantage of being easy to implement, since the preform is obtained by weaving. Moreover, the method according to the invention has the advantage of requiring a smaller quantity of fibers used than in the prior art, which limits the production cost.

According to other features of the invention, the method according to the invention includes one or several of the following optional features, considered alone or according to all possible combinations:
in step (A) and step (B), part of the binder fibers is woven so as to bind the weft fibers of different weft layers,
in step (A) binder fibers are woven so as to bind at least two different layers of the central body and, in step (B), the binder fibers of each side part are woven so as to bind the weft fibers in a single weft layer,
in step (A) and step (B), substantially all of the binder fibers are woven binding the weft fibers of a same weft layer,
the method according to the invention comprises an additional step where the set of weft layers of the central body and/or of the side edges are sewn by a plurality of additional fibers substantially perpendicular to the median plane,
at least one additional fiber forms a non-zero implantation angle with the normal of the median plane,
the method according to the invention comprises a step where the end weft fibers belonging to the end surface weft layers are bound to substantially all of the binder fibers belonging to the end of a side part.

According to a third aspect, the invention concerns a hollow structural mechanical part obtained from at least two preforms according to the invention or able to be obtained using the method according to the invention.

The hollow body can be a structural box.

Generally, the part of the invention can be a hollow part whereof the length is larger than the width. Preferably, the part according to the invention is a rod. Other examples are rods supporting significant loads, such as landing gear rods, rods stressed in traction or compression, bogie structures, box structures for producing attachment masts.

Preferably, a plurality of additional fibers substantially transversely binds at least one junction of side parts of two preforms.

### BRIEF DESCRIPTION OF THE DRAWINGS

The invention will be better understood upon reading the following non-limiting description, done in reference to the appended figures.

FIG. 1 is a cross-section of a weaving mode using the 2D pattern,

FIG. 2 is a cross-section of a weaving mode using the 2.5D pattern,

FIG. 3 is a schematic perspective view of a preform according to the invention,

FIG. 4a is a longitudinal schematic cross-section of one embodiment of the central body of the preform of FIG. 3 along cross-section IVa-IVa,

FIG. 4b is a longitudinal schematic cross-section of an embodiment of the side parts of the preform of FIG. 3 along cross-section IVb-IVb,

FIGS. 5a and 5b are an alternative of the embodiment of the preform of FIGS. 4a and 4b,

FIGS. 6a and 6b are another alternative of the embodiment of the preform of FIGS. 4a and 4b,

FIG. 6c is a transverse cross-section of the central body of an alternative of the embodiment of FIGS. 6a and 6b,

FIGS. 7a to 7b are schematic transverse cross-sections of the side part of the preform according to the invention,

FIGS. 8a to 8b are schematic transverse cross-sections of a side part of the preform according to the invention,

FIG. 9 is a schematic transverse cross-section of a mechanical part of the invention obtained from two preforms according to the invention,

FIG. 10 is an enlargement of area X of FIG. 9.

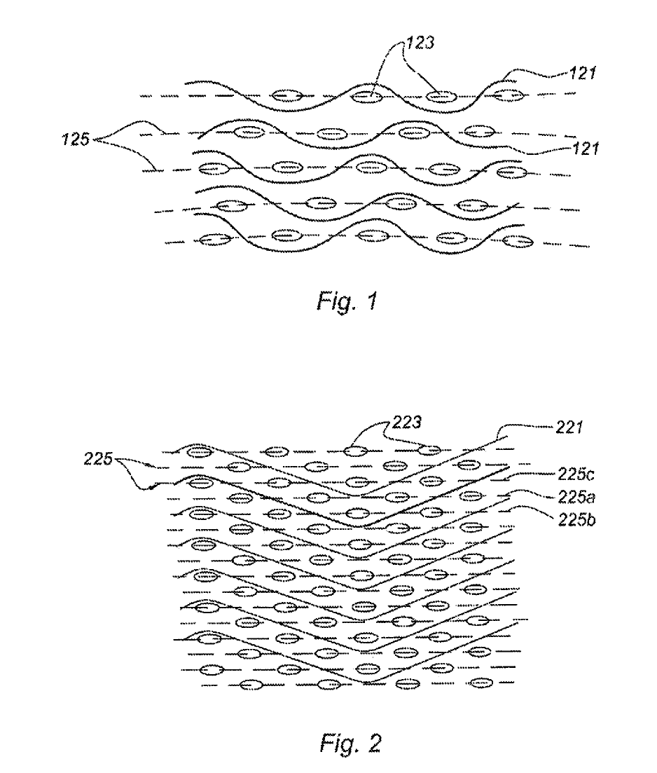

### DETAILED DESCRIPTION

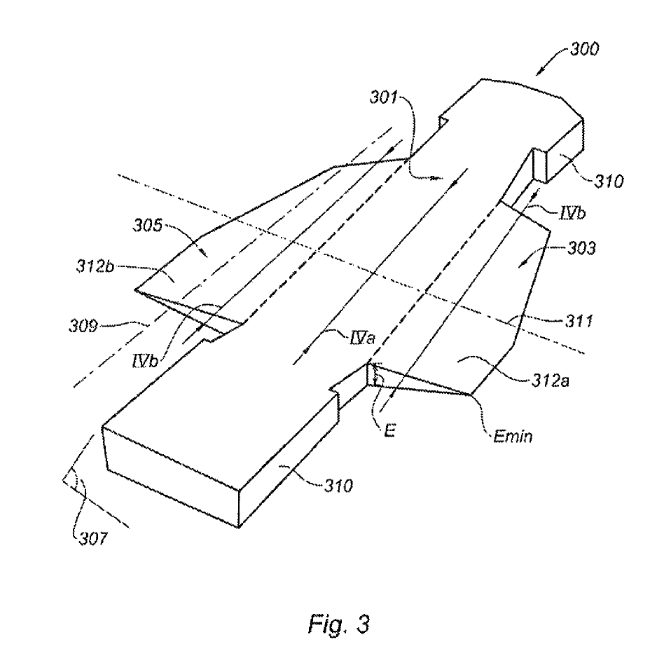

As illustrated in FIG. 3, the preform 300 of the invention includes a central body 301 and two side parts 303 and 305. The preform of the invention 300 thus illustrated is intended to wind with another preform of the invention in order to provide a hollow structural mechanical part of the invention. Nevertheless, the preform of the invention 300 can wind on itself or be connected to more than two preforms according to the invention.

The central body 301 forms a median plane 307 and extends substantially along a main axis 309 contained in the median plane 307. The central body 301 includes two end parts 310 that are not intended to be wound. Generally, the two end parts 310 have a shape adapted to the subsequent use of the hollow part, such as the formation of flanks of a connecting rod cap. Typically, these end parts 310 have a constant or even increasing thickness moving away from the central part of the central body 301. The thickness of the end parts 310 can be increased as needed by applying, for example, the method described in patent application WO 2007/060305.

The central body 301 can have a non-uniform thickness so as locally to have overthicknesses in order to mechanically strengthen certain areas of said body 301.

The two side parts 303 and 305 extend along the median plane 307 along a secondary axis 311 substantially perpendicular to the main axis 309.

Each side part 303 and 305 of the preform according to the invention has a thickness E that decreases moving away from the central body 301 along the secondary axis 311. In other words, the transverse section of each side part 303 and 305 is substantially trapezoidal, or even triangular. Each part 303 and 305 then has a junction surface 312a and 312b.

Thus, when two side parts of the invention belonging to the same preform of the invention or to two separate preforms are joined, the junction area has a substantially rectangular transverse section corresponding to the superposition of two trapezoidal or triangular side parts.

Moreover, the central body and each side part comprise weft fibers bound to each other by binder fibers, said weft fibers extending along parallel planar weft layers. The weft layers are superimposed on each other.

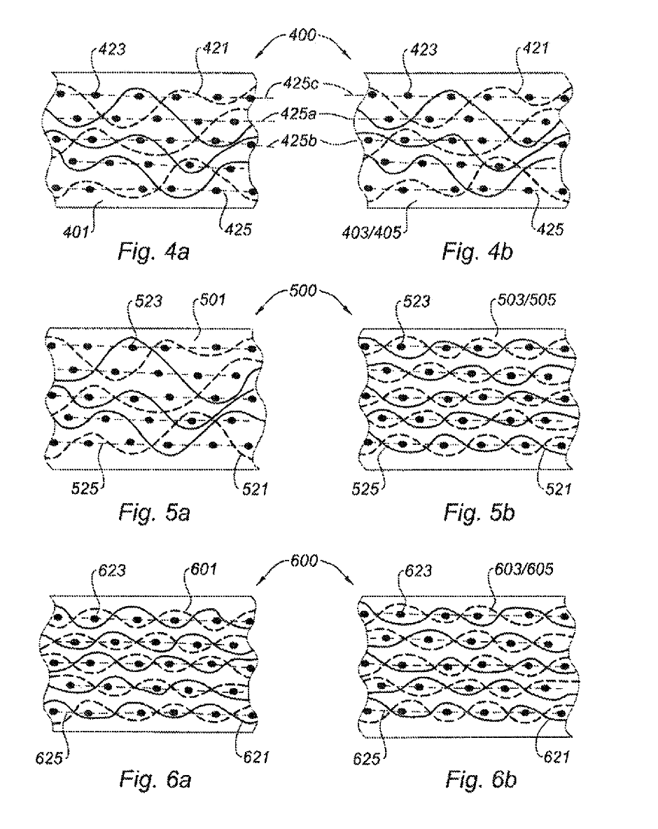

More precisely, according to an embodiment illustrated in FIGS. 4a and 4b, at least part of the binder fibers 421 binds weft fibers 423 of the central body 401 and of each side part 403, 405, the weft fibers 423 belonging to different weft layers 425. In other words, a same binder fiber 421 typically binds a weft layer 425a and also the adjacent weft layers 425b and 425c. Because of this, the preform of the invention 400 has very good mechanical resistance.

According to another embodiment illustrated in FIGS. 5a and 5b, the binder fibers 521 bind weft fibers 523 of a same weft layer 525 in each side part and said binder fibers 521 bind the weft fibers 523 belonging to different weft layers 525 in the central body 501. Such a configuration makes it possible to improve the sliding of the different weft layers 525 during winding and avoid any buckling and distortions of the weft fibers 523. The alignment of these weft fibers 523 is thus improved, which further improves the mechanical resistance of the junction area between the two side parts 503 and 505.

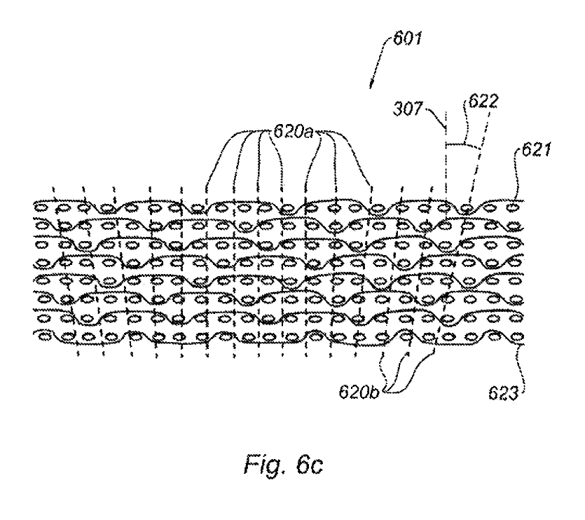

According to still another embodiment illustrated in FIGS. 6a and 6b, substantially all of the binder fibers 621 bind weft fibers 623 of a same weft layer 625, said weft fibers 623 belonging to the central body 601 and to each side part 603, 605. Such a configuration makes it possible to decrease the number of weft fiber 623 drops, thereby ensuring savings in terms of time and weft fibers 623.

Moreover, the wave angles in the thickness of the binder fibers 621 are reduced, which improves the compressive strength of the preform 600 of the invention.

It is also possible to preweave the different weft layers 625. In this alternative, the orientations of these weft layers 625 may be chosen so as to optimize the orientations of the weft fibers 623 after winding to still further improve the stress resistance of the structural mechanical part. The preform of the invention 600 is then formed flat by a stack of weft layers 625, the dimension and geometry of each weft layer 625 being able to be adjusted precisely. In the case where the binder fibers 621 of the central body are only bound with a thickness of weft fibers 623, the longitudinal mechanical resistance properties of the structural mechanical part are improved.

The preform of the invention 400, 500 and 600 advantageously has a central body 401, 501 and 601 with a fairly significant stiffness granting it good mechanical resistance as well as sufficient cohesion to avoid any degradation or disorientation of the weft fibers 423, 523 and 623 during winding. For the side parts 403, 405, 503, 505, 603, and 605, they must have a stiffness that is not too high for them to be handleable during the winding of the preform of the invention 400, 500, and 600. Indeed, in general, the central body 400, 500 and 600 is not intended to be wound according to a significant winding angle. Because of this, it is not necessary for it to have weft fiber layers 425, 525, and 625 able to slide on each other so as to obtain good alignment of the weft fibers 423, 523, and 623. On the other hand, it is important for the weft fibers 423, 523 and 623 of the side parts 403, 405, 503, 505, 603, and 605 to be able to slide in relation to each other in order to allow an optimal junction and keep the straightness of the weft fibers 423, 523 and 623 to ensure good mechanical resistance of each side part and of the junction.

In order to strengthen the stiffness and mechanical resistance of the central body 401, 501 and 601, the weft fibers 423, 523 and 623 and the binder fibers 421, 521 and 621 can be bound in the area of the central body 401, 501 and 601 and/or of the side parts 403, 405, 503, 505, 603, and 605 by a plurality of additional fibers substantially perpendicularly to the median plane 307 to strengthen the mechanical resistance of the preform of the invention 400, 500 and 600. Thus, the preform of the invention 400, 500 and 600 is more easily handleable. The mechanical resistance of the central body 401, 501 and 601 is also thereby improved. The additional fibers can be joined together using any means known by those skilled in the art, in particular by sewing or studding.

In particular, in the case of the embodiment illustrated in FIGS. 6a and 6b, the central body 601 is sewn by the plurality of additional fibers 620a and 620b in order to give a cohesion to the preform of the invention 600 (see FIG. 6c).

A plurality of additional fibers 620a has a substantially non-zero implantation angle 622 with the normal of the median plane 307. Each additional fiber 620a then intersects the preform of the invention along substantially the normal at the median plane 307. According to one preferred alternative, at least one additional fiber 620b forms a non-zero implantation angle 622 with the median plane 307. More specifically, the implantation angle 622 depends on the winding angle at the points where the additional fiber 620a and 620b comes out of the preform according to the invention. The winding angle corresponds to the angle between a reference point and the point of intersection between the additional fiber and one of the two faces of the preform of the invention with the normal. Such a configuration makes it possible to improve the sliding of the weft layers 425, 525, and 625, and to thereby obtain a winding adapted to the geometry of the structural mechanical part. The winding angle is typically greater than twice the sinus of the implantation angle, which makes it possible not to hinder the sliding of the weft layers during winding.

According to one alternative, the preform 400, 500 and 600 can be shaped before performing the sewing operation.

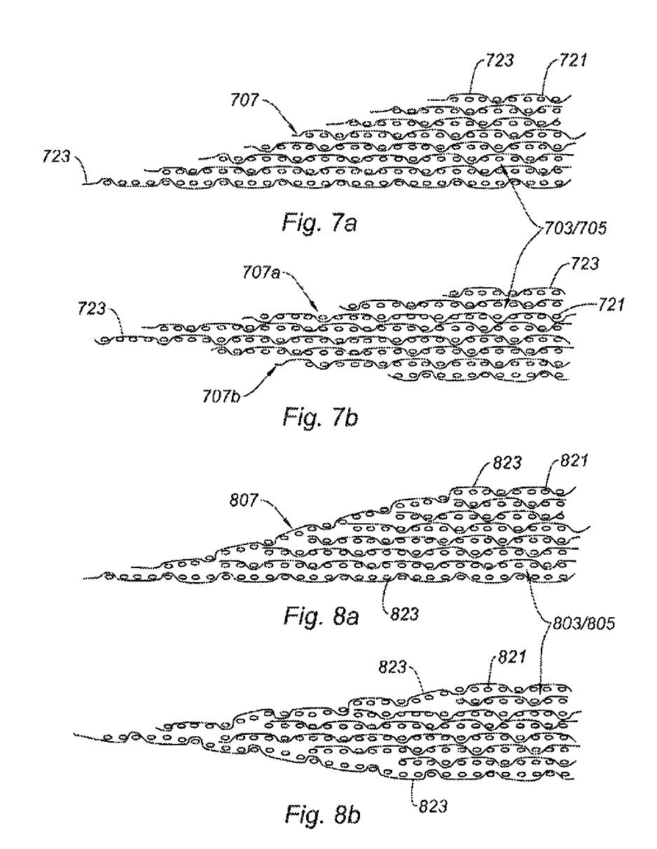

According to the embodiment illustrated in FIG. 7a, the weft fibers 723 of a side part can be cut at the junction surface 707 so as to form a digressive slope. It is also possible to cut the weft fibers 723 symmetrically or asymmetrically so as to form two digressive slope surfaces 707a and 707b (see FIG. 7b).

According to one preferred embodiment illustrated in FIGS. 8a and 8b, the surface weft fibers 823 belonging to the surface end weft layers substantially bind all of the binder fibers 821 belonging to the end of a side part 803 and 805. The binder fibers 821 situated at the end of each side part 803 and 805 are protected and the junction surface 807 is formed by a continuous layer of weft fibers 823 favoring the continuity of stress transfer between the two joined side parts 803, 805. It is also possible for one of the two end weft fibers 823 to be longer than the other.

It is also possible to mix the two embodiments presented above. To that end, it is possible for the surface weft fiber of a surface end weft layer not to bind all of the binder fibers situated at the end of a side part, but only a few binder fibers. Thus, the surface weft fiber is cut after having bound several binder fibers. The weft fiber situated below that cut takes the place of the cut surface weft fiber and in turn binds several binder fibers situated at the end of the side part. One thus starts again until reaching the end of the side part.

The rates of weft and binding fibers of the preform of the invention are generally linked to the dimension of the structural mechanical part to be obtained. To produce structural mechanical parts whereof the thickness varies between 8 mm and 70 mm, the binder and weft fibers are generally made up of 12,000 to 96,000 individual carbon filaments. It is possible to use fibers having 1,000 to 12,000 individual carbon filaments to produce the edges and seams of the preform according to the invention. Typically, the diameter of a binder fiber is between one fiftieth and five times the diameter of the weft fiber and in particular comprises between 1,000 and 48,000 carbon filaments.

The distance between two weft fibers 423, 523, 623, 723 and 823 of a same weft layer 425, 525 and 625 is typically between 1 mm and 10 mm, in particular equal to about 5 mm for a preform of the invention including fibers of 12,000 to 96,000 individual carbon filaments. Likewise, the distance between two binder fibers 421, 521, 621, 721 and 821 of a same weft layer 425, 525 and 625 is between 0.5 and 5 mm, in particular equal to about 2 mm for the case of a preform according to the invention including fibers with 12,000 to 96,000 individual carbon filaments.

The rate of weft fibers 423, 523, 623, 723 and 823 in the preform of the invention is generally between 25% and 70%. Likewise, the level of binder fibers 421, 521, 621, 721 and 821 is generally between 30% and 75%.

The weft fibers 423, 523, 623, 723 and 823 and the binder fibers 421, 521, 621, 721 and 821 are typically Kevlar®, carbon fibers or glass fibers.

It is possible to use weft fibers 423, 523, 623, 723 and 823 and/or binder fibers 421, 521, 621, 721 and 821 of different natures, in particular having a flexibility adapted to bind or border the main weaves. It is also possible to use weft fibers 423, 523, 623, 723 and 823 and/or binder fibers 421, 521, 621, 721 and 821 integrating orientation markers of core fibers of the preform according to the invention.

The number of weft layers 425, 525 and 625 is typically between 5 and 100, between 5 and 80, even between 9 and 24.

The value of the slope of each side part 303, 305, 403, 405, 503, 505, 603, 605, 703, 705, 803 and 805 is determined as being the level difference between thickness point Emax and thickness point Emin of said side part. As an example, the value of the slope is in particular between 1 mm long for 1 mm thick and 20 mm long for 1 mm thick, preferably between 3 mm long for 1 mm thick and 12 mm long for 1 mm thick, which makes it possible to obtain an optimal junction after winding.

Typically, the value of thickness Emax is between 6 mm and 100 mm, or even between 9 mm and 30 mm.

The minimum thickness Emin preferably corresponds to the diameter of a weft fiber 423, 523, 623, 723 and 823 or of two weft fibers. Typically, the diameter of a weft fiber 423, 523, 623, 723 and 823 is between 0.1 mm and 2 mm, or even between 0.5 mm and 1 mm.

Preferably, the diameters of the binder fibers 421, 521, 621, 721 and 821 of at least one side part are of different values. Such a configuration makes it possible to obtain finer weft layers 425, 525, and 625, in particular at the minimum thickness end Emin of the side parts. Because of this, the slope profile can advantageously be adjusted according to usage needs.

Typically, the diameter of the binder fibers 421, 521, 621, 721 and 821 is between 0.1 mm and 2 mm, or even between 0.5 mm and 1 mm.

Typically, the additional fibers have a maximum diameter of 0.5 mm corresponding for example to a fiber including from 1,000 to 12,000 individual carbon filaments. The rate of additional fibers does not exceed 5% of the level of weft and binder fibers. The implantation pitch of the additional fibers can be at least equal to 1 mm and in particular in the vicinity of 3 to 7 mm.

Due to the configuration of the side parts 303, 305, 403, 405, 503, 505, 603, 605, 703, 705, 803 and 805, the weft fibers 423, 523, 623, 723 and 823 are not misaligned, which markedly improves the mechanical resistance of that junction area.

The preform according to the invention has the advantage of weight savings in relation to the prior art because fewer weft and binder fibers are used to form the side parts.

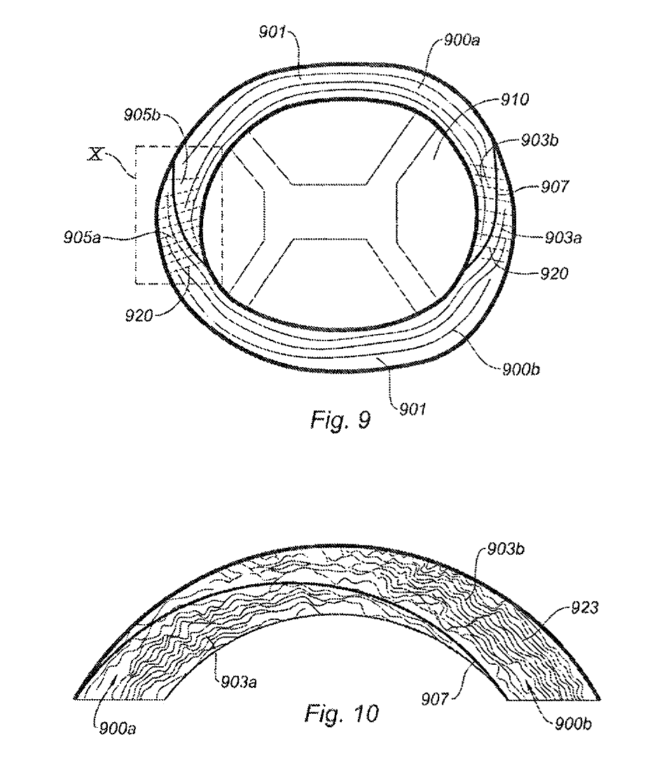

In the case illustrated in FIGS. 9 and 10, when two preforms of the invention 900a and 900b are joined to form a hollow mechanical part, for example around a core 910, the junction surface of the two side parts 903a and 903b belonging, for example to two distinct preforms of the invention 900a and 900b, are able to be situated opposite each other to form a junction area 907. It is also possible to have a junction between two side parts belonging to a same preform of the invention.

The junction area 907 is advantageously broader than in the prior art owing to the slope of the side parts 903 and 905 and to the maintenance of the alignment of the weft fibers 923, which slide in relation to each other more easily. Because of this, good closing of the preform(s) according to the invention is obtained, thereby resulting in good mechanical resistance of the junction area 907.

Moreover, the weft fibers 923 are not misaligned, which markedly improves the mechanical resistance of this junction area 907.

The preform according to the invention also has the advantage of weight savings in relation to the prior art because fewer weft and binder fibers are necessary to form the side parts and achieve the desired mechanical resistance of the junction.

According to another aspect of the invention, the preform of the invention 300, 400, 500, 600, 900a and 900b is obtained using a production method including a step A for forming a central body 301, 401, 501, 601 and 901 comprising along a median plane 307 then a step B for forming two side portions 303, 305, 403, 405, 503, 505, 603, 605, 703, 705, 803, 805, 903a and 903b along a thickness that decreases moving away from the central body 301, 401, 501, 601, and 901 along a secondary axis 311, each side portion 303, 305, 403, 405, 503, 505, 603, 605, 703, 705, 803, 805, 903a and 903b being substantially contained in the median plane 307, the central body 301, 401, 501, 601 and 901 and each side part 303, 305, 403, 405, 503, 505, 603, 605, 703, 705, 803, 805, 903a and 903b comprising weft fibers 423, 523, 623, 723, 823 and 923 bound to each other by binder fibers 421, 521, 621, 721 and 821, said binder fibers 423, 523, 623, 723, 823 and 923 extending along parallel planar weft layers 325, 425, 525 and 625.

The weaving of the preform of the invention 300, 400, 500, 600, 900a and 900b is done using any means known by those skilled in the art, in particular using computer-assisted automated means. One example is a jacquard-type weaving technique controlled by a digital control, a system for cutting weft layers by water jet or laser beam controlled by a digital control, a machine for implanting the additional fibers controlled by a digital control.

According to one preferred embodiment, in step A and step B, part of the binder fibers 421 is woven so as to bind the weft fibers 423 of different weft layers 425.

According to another preferred embodiment, in step A binder fibers 521 are woven so as to bind at least two different layers 525 of the central body 501 and, in step B, the binder fibers 521 of each side part 503, 505 are woven so as to bind the weft fibers 523 of a single weft layer 525.

According to still another preferred embodiment, in step A and step B, substantially all of the binder fibers 621 are woven binding the weft fibers 623 of a same weft layer 625.

Preferably the method of the invention includes an additional step for sewing all of the weft layers 325, 425, 525 and 625 of the central body by a plurality of additional fibers 620a and 620b substantially perpendicularly to the median plane 307. The preform 300, 400, 500, 600, 900a and 900b thus obtained then has very good mechanical resistance. In particular, the latter has better cohesion and becomes easy to handle, without degradation of the initial relative orientations of the weft and binder fibers. At least one additional fiber forms a substantially non-zero 620a, or preferably non-zero 620b, implantation angle 622 with the normal of the median plane 307. The implantation angle 622 typically depends on the winding angle, which makes it possible to improve the sliding of the weft layers and thereby obtain the necessary winding for the geometry of the structural part.

Preferably, the method of the invention comprises a step for binding the surface weft fibers 823 belonging to the surface end weft layers substantially all of the binder fibers 821 belonging to the end of a side part 803 or 805.

After the preform of the invention 300, 400, 500, 600, 900a and 900b is formed, it is then wound around any suitable support known by those skilled in the art such that the junction surfaces are able to be situated opposite another junction surface. In practice, the preform of the invention 300, 400, 500, 600, 900a and 900b can be surrounded by itself. But more interestingly, said preform 900a is joined in this way to another preform 900b, or even to two or more other preforms, around a suitable core 910 (see FIGS. 9 and 10). The advantage of joining several preforms of the invention lies in the fact that the preforms thus obtained have smaller dimensions and are therefore easier to handle. It is thus possible to favor, for each preform of the invention, a specific orientation of the weft fibers and of the binder fibers, orientation typically chosen to ensure alignment with the stresses undergone by the mechanical part. Another advantage consists of the design of the geometries of mechanical parts with evolving sections and therefore the optimization of those parts.

The preform(s) of the invention 900a and 900b thus joined assume the shape of a structural mechanical part 910 having a hollow or recess.

It is then finally possible, in order to consolidate the junction area 907, to bind through a plurality of additional fibers 920 substantially transversely to the junction.

This binding has the multiple advantage of strengthening the mechanical resistance of the fibrous structure in that area, making the ends of the preforms joined to each other integral with each other, and therefore maintaining those parts together as well as the relative orientations of the weft fibers of each part, until the final molding arrangement.

The finished hollow mechanical part can then be obtained by injecting, for example, a resin using the resin transfer molding (RTM) technique in the unfinished structural mechanical part having a hollow or recess. However, any other type of resin injection known by those skilled in the art can be suitable. Examples of resin usually used include RTM injection resins, such as epoxy resins, imide bismaleimide resins, or phenolic resins.

Preferably, the mechanical part has a finished size for the inner and outer faces of the hollow body. The shape completion can be done using any known machining and cutting method so as to perform, for example, trimming of the end areas of the hollow area(s) or axis implantation bores, such as placement and fastening surfacing and piercing for fittings and other assemblies with other structures.

The hollow structural mechanical part thus obtained can for example be a rod, in particular a landing gear rod or any other structural part of an aircraft.

1. A preform intended to form a hollow structural mechanical part, said preform comprising:
a central body forming a median plane and extending substantially along a main axis contained in the median plane, and
two side parts extending substantially along the median plane along a secondary axis substantially perpendicular to the main axis,
the central body and each side part including weft fibers bound to each other by binder fibers, said weft fibers extending along substantially parallel planar weft layers,
wherein the thickness (E) of each side part decreases along the secondary axis moving away from the central body.

2. The preform according to claim 1, wherein at least part of the binder fibers binds weft fibers of the central body and each side part belonging to different weft layers.

3. The preform according to claim 1, wherein the binder fibers bind weft fibers of a same weft layer in each side part and said binder fibers bind the weft fibers belonging to different weft layers in the central body.

4. The preform according to claim 1, wherein substantially all of the binder fibers bind weft fibers of a same weft layer, said weft fibers belonging to the central body and each side part.

5. The preform according to claim 1, wherein the weft fibers of the central body and/or of the side parts are bound by a plurality of additional fibers substantially perpendicular to the median plane.

6. The preform according to claim 5, wherein at least one additional fiber forms a non-zero implantation angle with the normal of the median plane.

7. The preform according to claim 1, wherein diameters of the binder fibers of at least one side part have different values.

8. The preform according to claim 1, wherein a minimum thickness of each side part corresponds to the diameter of a weft fiber or of two weft fibers.

9. The preform according to claim 1, wherein a diameter of a binder fiber is between one fifth and five times the diameter of a weft fiber.

10. The preform according to claim 1, wherein a value of a slope of each side part is between 3 mm long for 1 mm thick and 15 mm long for 1 mm thick.

11. The preform according to claim 1, wherein a diameter of the weft fibers of a last layer or of the last two layers of the side parts have values lower than the diameter of the weft fibers of the other weft layers.

12. The preform according to claim 1, wherein end weft fibers belonging to end weft layers substantially bind all of the binder fibers belonging to an end of a side part.

13. A method for producing a preform according to claim 1, comprising a step (A) for forming a central body comprising along a median plane then a step (B) for forming two side parts along a thickness that decreases along the secondary axis moving away from the central body, each side part being substantially contained in the median plane, the central body and each side part comprising weft fibers bound to each other by binder fibers, said weft fibers extending along parallel planar weft layers.

14. The method according to claim 13, wherein in step (A) and step (B), part of the binder fibers is woven so as to bind the weft fibers of different weft layers.

15. The method according to claim 13, wherein in step (A) binder fibers are woven so as to bind at least two different layers of the central body and, in step (B), the binder fibers of each side part are woven so as to bind the weft fibers in a single weft layer.

16. The method according to claim 13, wherein in step (A) and step (B), substantially all of the binder fibers are woven binding the weft fibers of a same weft layer.

17. The method according to claim 13, further comprising an additional step where the set of weft layers of the central body and/or of the side parts are sewn by a plurality of additional fibers substantially perpendicular to the median plane.

18. The method according to claim 17, wherein at least one additional fiber forms a non-zero implantation angle with the normal of the median plane.

19. The method according to claim 13, further comprising a step where the end weft fibers belonging to the end surface weft layers are bound to substantially all of the binder fibers belonging to the end of a side part.

20. A hollow structural mechanical part able to be obtained by the method according to claim 13.

21. The part according to claim 20, wherein it is a rod.

22. The part according to claim 20, wherein a plurality of additional fibers substantially transversely binds at least one junction of side parts of two preforms.
